(19) United States
(12) Patent Application Publication
(10) Pub. No.: US 2017/0237752 A1
(43) Pub. Date: Aug. 17, 2017

(54) PREDICTION OF POTENTIAL CYBER SECURITY THREATS AND RISKS IN AN INDUSTRIAL CONTROL SYSTEM USING PREDICTIVE CYBER ANALYTICS

(71) Applicant: Honeywell International Inc., Morris Plains, NJ (US)

(72) Inventors: Ritwik Ganguly, Bangalore (IN); Avinash Rajan, Bangalore (IN); Praveen R. Shetty, Bangalore (IN); Ganesh P. Gadhe, Pune (IN)

(21) Appl. No.: 15/042,054

(22) Filed: Feb. 11, 2016

(51) Int. Cl. H04L 29/06; G06N 5/04; H04L 12/58; G06F 21/57

(52) U.S. Cl. CPC H04L 63/1416; H04L 63/1433; G06F 21/577; G06N 5/04; H04L 51/046; G06F 2221/034

(57) ABSTRACT

This disclosure provides systems and methods for prediction of potential cyber security threats and risks in an industrial control system using predictive cyber analytics. A method includes receiving, by a risk manager system, real-time data from a plurality of connected devices. The method includes creating, by the risk manager system, a data model based on the real-time data. The method includes analyzing, by the risk manager system, the data model to identify potential current threats. The method includes predicting, by the risk manager system, potential threats. The method includes notifying a user, by the risk manager system, of the potential threats.

### TECHNICAL FIELD

This disclosure relates generally to industrial control system security. More specifically, this disclosure relates to an apparatus and method for tying cyber-security risk analysis to common risk methodologies and risk levels.

### BACKGROUND

Process plants are often managed using industrial process control and automation systems. Conventional control and automation systems routinely include a variety of networked devices, such as servers, workstations, switches, routers, firewalls, safety systems, proprietary real-time controllers, and industrial field devices. Often times, this equipment comes from a number of different vendors. In industrial environments, cyber-security is of increasing concern, and unaddressed security vulnerabilities in any of these components could be exploited by attackers to disrupt operations or cause unsafe conditions in an industrial facility.

### SUMMARY

This disclosure provides apparatuses and methods for prediction of potential cyber security threats and risks in industrial control system using predictive cyber analytics. A method includes receiving, by a risk manager system, real-time data from a plurality of connected devices. The method includes creating, by the risk manager system, a data model based on the real-time data. The method includes analyzing, by the risk manager system, the data model to identify potential current threats. The method includes predicting, by the risk manager system, potential threats. The method includes notifying a user, by the risk manager system, of the potential current threats and predicted potential threats.

A method includes receiving, by a risk manager system, real-time data from a plurality of connected devices. The method includes monitoring real-time operations data, such as control system security related data, cyber-security data, or other data, by the risk manager system. The method includes creating, by the risk manager system, a data model based on the correlation of real-time data and profiling the unusual behavior of control system operations. The method includes analyzing, by the risk manager system, the data model to discover hidden but meaningful patterns in raw data, to establish apparently unknown correlations in order to get intelligent insights of the system. The method includes prediction of potential cyber threats and risks with the help of cyber data analytics. The method includes notifying a user, by the risk manager system, of the potential threats.

In various embodiments, the data model is analyzed by correlating real-time data with cyber threat intelligence to discover patterns and to establish a correlation between the patterns in order to identify the potential current threats or predicted potential threats. In various embodiments, analyzing the data model includes identifying security gaps which contribute to the potential current threats or predicted potential threats. In various embodiments, the risk manager system also prioritizes the potential current threats or predicted potential threats. In various embodiments, notifying the user is performed by one of email notification, text message notification, or via a dashboard. In various embodiments, the predicted potential threats are predicted based on at least one of the data model, cyber-threat intelligence, or the potential current threats

Other technical features may be readily apparent to one skilled in the art from the following figures, descriptions, and claims. Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases may be provided throughout this patent document, and those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates a predictive cyber analytics framework in accordance with disclosed embodiments; and

FIG. 3 illustrates a flowchart of a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

There is rapid evolution of cyber-security threats and incidents in industrial control systems (ICS) by a variety of malicious sources. The impacts of these attacks are at times production loss to equipment, environmental damage and even loss of human lives.

The current approach of gathering data on a compromise is developing a threat's “signature” and then using that signature to protect against future threats. This approach results in significant time delays before threats can be effectively detected. There are some other security systems that provide information about global threat ecosystems through geospatial mapping of threats. There are security information and event management systems which mostly provide a dump of raw data into an already data-overloaded system which does not help to narrow down the security problem, but rather compounds it.

In the case of ICS, it is far more complex to sustain continuous production and maintain personnel/equipment safety considering the stringent up-time requirements of an ICS. The level of contextual information about ICS provided by standard IT security systems is inadequate and insufficient in order to appropriately identify and resolve cyber threats in an ICS environment.

Conventional security systems provide cyber threat intelligence for information technology (IT) worlds, but do not provide contextual information based on ICS real-time operations. The lack of ongoing monitoring of threat actors/vectors in ICS can cause significant gaps in timely identification of cyber threats before it causes significant harm in the system. Conventional methods for detecting cyber threats in ICS are reactive and provide a post-attack view of what already happened, but it does not tell either what the next attack will likely be or what threats are emerging.

The cyber threat intelligence information about global threat ecosystems demands a manual response to protect the system from specific threat. With manual evaluation of cyber threat intelligence, analyzing real-time ICS security information and corresponding action becomes exhaustive and time consuming. The current security systems provide too much unstructured and unfiltered data, which causes information overload.

Disclosed embodiments provide predictive, accurate insights on the risks and threats relevant to ICS specific situations at a speed and format that enables an efficient, effective and integrated response. Disclosed embodiments can predict potential threats and risks based on strategic analysis of threat intelligence and correlation of real-time data.

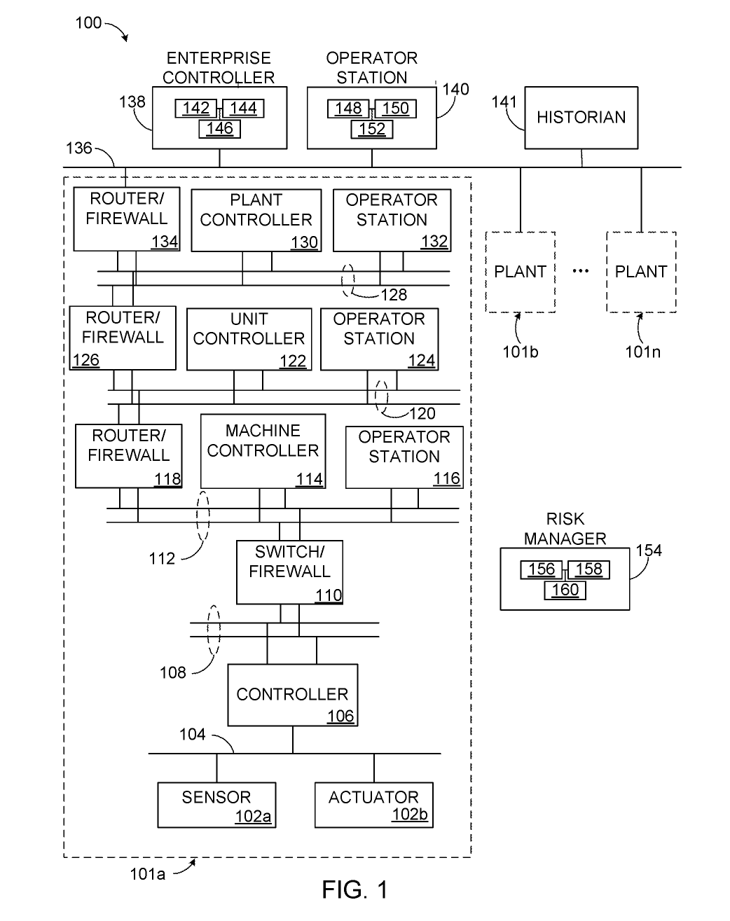

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level to controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

As noted above, cyber-security is of increasing concern with respect to industrial process control and automation systems. Unaddressed security vulnerabilities in any of the components in the system 100 could be exploited by attackers to disrupt operations or cause unsafe conditions in an industrial facility. However, in many instances, operators do not have a complete understanding or inventory of all equipment running at a particular industrial site. As a result, it is often difficult to quickly determine potential sources of risk to a control and automation system.

Disclosed embodiments can analyze cyber-security data and provide predictive analysis of potential security risks. This is accomplished (among other ways) using a risk manager 154. Among other things, the risk manager 154 supports a technique for analysis and prediction of cyber-security risks in ICS and other systems. The risk manager 154 includes any suitable structure that supports automatic handling of cyber-security risk events. Here, the risk manager 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the risk manager 154 could be implemented using any suitable hardware or a combination of hardware and software/firmware instructions.

Disclosed embodiments provide predictive cyber analytics for ICS to predict potential threats and risks using predictive data analytics to reduce cyber incidents. The disclosed predictive cyber analytics method, by contrast to traditional methods, identifies potential threats as they come on the scene by identifying anomalous patterns using unique real-time cyber data analytics.

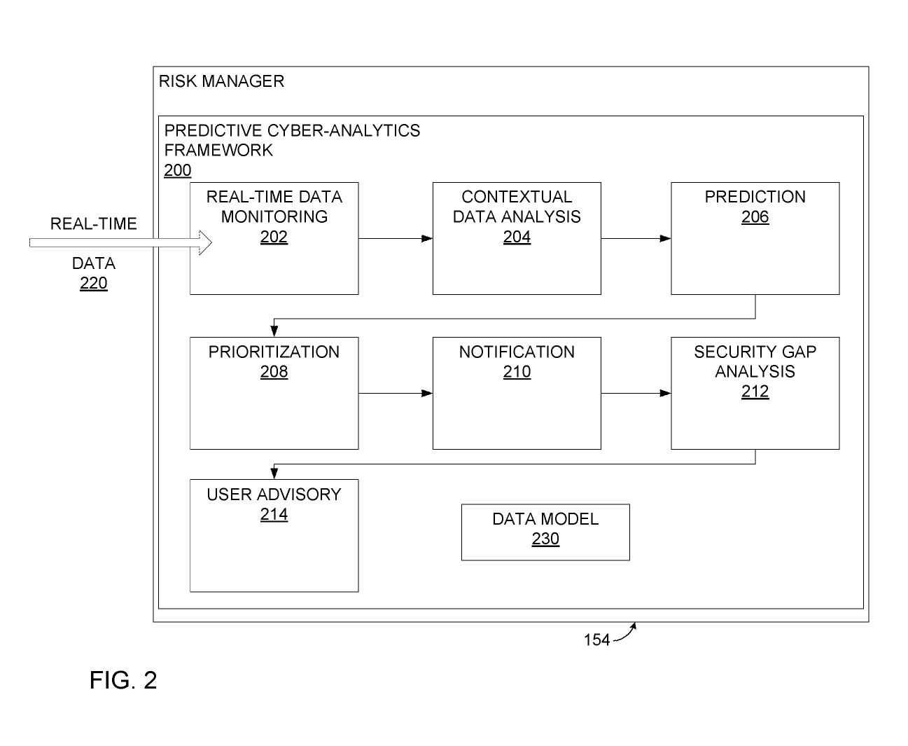

FIG. 2 illustrates a predictive cyber analytics framework 200 in accordance with disclosed embodiments, which can be implemented, for example, by a risk manager 154.

Framework 200 includes a real-time data monitoring module 202 that can be implemented or executed, for example, by one or more of the processing devices 156. Real-time data monitoring module 202 monitors real-time data streams and events from ICS embedded nodes, servers/clients, switches/routers, or other elements of an ICS such as illustrated in FIG. 1, and also user interactions and responses to learn the contexts and patterns. In this way, the framework 200 can learn the “normal” behavior of the ICS.

Framework 200 includes a contextual data analytics module 204 that can be implemented or executed, for example, by one or more of the processing devices 156. The contextual data analytics module 204 can create a data model 230 and analyze it by correlating real-time data and relevant cyber threat intelligence. The contextual data analytics module 204 can then analyze the data model 230 for potential threats. Potential threats can include any suspicious events or discrepancy in expected behavior or pattern that is significant or sustained. The cyber-threat intelligence can include, for example, computer virus or threat definitions, heuristics, third-party-supplied data, historical threat information, and others.

Framework 200 includes a prediction module 206 that can be implemented or executed, for example, by one or more of the processing devices 156. The prediction module 206 can predict potential threats and risks based on the data model or pattern analysis. The risk manager can use advanced decision-making techniques that correlate and analyze multiple security data. Disclosed systems also include machine learning capabilities, which allows the system to learn and adapt based on what the received data. Machine learning systems look for where risks might be, based on past evidence of an incident that has taken place, is under way, or might be imminent.

Framework 200 includes a prioritization module 208 that can be implemented or executed, for example, by one or more of the processing devices 156. The prioritization module 208 can prioritize the potential threats and risks predicted by the data model to help users to make informed decisions.

Framework 200 includes a notification module 210 that can be implemented or executed, for example, by one or more of the processing devices 156. The notification module 210 provides advance warning about the potential threats and risks on a dashboard or via text message, email, or other means, well before the actual compromises take place, creating more time for analysis and planning any corrective action. The notifications can be based on the prioritization.

Framework 200 includes a detail security gap analysis module 212 that can be implemented or executed, for example, by one or more of the processing devices 156. The detail security gap analysis module 212 further analyzes the real-time data and data model to identify security gaps which contribute to potential threats.

Framework 200 includes a user advisory module 214 that can be implemented or executed, for example, by one or more of the processing devices 156. The user advisory module 214 provides information to the users, such as via a dashboard or otherwise, about identified security gaps to help the user understand the rationale behind identified potential threats and how to avoid them in future.

In order to identity current threats and predict potential cyber security threats and risks in ICS, various types of data sources are considered for real-time monitoring (and are included in real-time data 220) such as system and process events, system and application logs, system diagnostics, system performance, and network device logs such as Syslog. The data sources can also include control system network traffic such as netflow data, SNMP data, packet flow, etc. The data sources can also include system configuration and policy data, such as user configurations, security policies, etc.

The system, such as using framework 200, collects raw security-related data from various sources as real-time data 220, builds a data model 230, and analyzes data to predict potential threats.

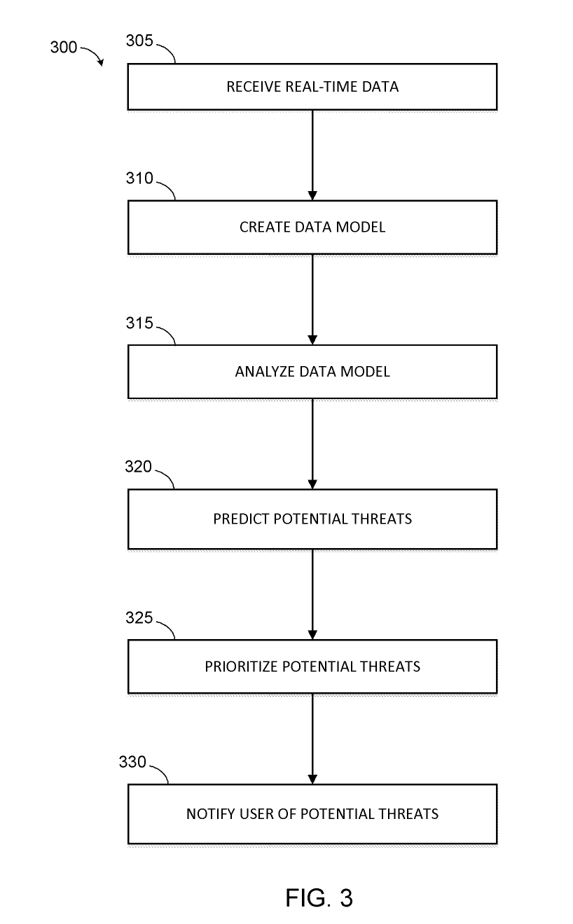

FIG. 3 illustrates a flowchart of a process 300 in accordance with disclosed embodiments, that can be performed, for example, by a risk manager 154 or other data processing system, referred to generically below as the “system” or “risk manager system.”

The system receives real-time data from a plurality of connected devices (305). These devices could be, for example, any of the devices illustrated in FIG. 1 or described above. The data can be cyber-security data.

The system creates a data model based on the real-time data (310).

The system analyzes the data model to identify potential current threats (315). This can be performed by correlating real-time data and cyber threat intelligence and can discover patterns and establish a correlation between the patterns in order to identify the potential threats. This can include identifying security gaps that contribute to potential threats.

The system predicts potential threats according to the data model, the cyber-threat intelligence, or the potential current threats (320). When used without a modifier, “potential threats” can include the potential current threats or predicted potential threats.

The system can prioritize the potential threats (325).

The system notifies a user of the potential threats, including the potential current threats or the predicted potential threats (330). This notification can be via a dashboard, email notification, text message notification, or otherwise. The notification can be based on the prioritization of the potential threats.

Following are non-limiting examples predictive cyber analytics cases in accordance with disclosed embodiments.

Disclosed embodiments can identify potential threats or risks in an ICS network. For example, the system monitors the ICS network devices, such as switches and routers, configuration file, and others, and determines that an IP Identification service and BOOTP Server service are enabled. The system can then analyze this configuration against the standard secured configuration and cyber-threat intelligence data. The system builds a contextual data model, and determines that an enabled IP Identification Service allows an attacker to query a TCP port and identify the router model number and the switch operating system used. An enabled IP BOOTP Server service allows an attacker to download the router's operating system software. It can also be used by an attacker to launch Denial-of-Service (DoS) attacks. The prediction engine of the data analytics then identifies these as potential threats/risks and issues a warning to the user.

The system can also monitor SNMP logs from the network device, and observe that SNMP vl is present. The system analyze that SNMP vl can cause security related risk, because SNMP vl uses community strings for authentication and they are sent across the network in plain text. The system predicts a potential threat and notifies a user.

Disclosed embodiments can identify potential threats or risks in an ICS controller and supervisory systems. For example, the system analyzes that an Experion Server administrator account password is not changed for a long time and there is an unusual pattern of administrator log in (e.g., 5 times in the last 10 days, compared to once a week in the past). This leads to a prediction that many users might know the password, and unauthorized users may be accessing the server. The system notifies a user for further investigation.

As another example, the system monitors the operating system events and finds that the system time has been changed in a Process Server process. The system provides a contextual analysis to determine that a change in a server clock can disrupt time synchronization in the system. An un-synchronized system clock can affect automated tasks and also can cause discrepancy in sequence of events in ICS environments. The system notifies a user for further investigation of the predicted potential threats.

As another example, the system monitors the operating system events logs and finds there is a change in windows firewall exception configuration in a Console operator station when the logged-on user does not have administrative privilege. The system builds contextual data analytics such as the logged on user profile and windows firewall exception event and determines that a malicious application has made unauthorized changes in the system. The system notifies a user for further investigation of the predicted potential threats.

As another example, the system monitors controller network traffic and file transfer logs, and identifies there is a sudden increase in display traffic to a specific system for a significant time in the overnight or other “off” hours. The system also finds that new software is copied into the node in the recent past which can potentially increase the display traffic load. The system can analyze and predict unauthorized information disclosure and probable tampering threats/risks, and notify a user.

As another example, the system identifies that there are multiple Bootp services running in the same cluster. The system can analyze this and predict a potential controller denial of service threat after a controller switchover, and notify a user.

Note that the risk manager 154 and/or the other processes, devices, and techniques described herein could use or operate in conjunction with any combination or all of various features described in the following previously-filed patent applications (all of which are hereby incorporated by reference):
U.S. patent application Ser. No. 14/482,888 entitled “DYNAMIC QUANTIFICATION OF CYBER-SECURITY RISKS IN A CONTROL SYSTEM”;
U.S. Provisional Patent Application No. 62/036,920 entitled “ANALYZING CYBER-SECURITY RISKS IN AN INDUSTRIAL CONTROL ENVIRONMENT”;
U.S. Provisional Patent Application No. 62/113,075 entitled “RULES ENGINE FOR CONVERTING SYSTEM-RELATED CHARACTERISTICS AND EVENTS INTO CYBER-SECURITY RISK ASSESSMENT VALUES” and corresponding non-provisional U.S. patent application Ser. No. 14/871,695;
U.S. Provisional Patent Application No. 62/113,221 entitled “NOTIFICATION SUBSYSTEM FOR GENERATING CONSOLIDATED, FILTERED, AND RELEVANT SECURITY RISK-BASED NOTIFICATIONS” and corresponding non-provisional U.S. patent application Ser. No. 14/871,521;
U.S. Provisional Patent Application No. 62/113,100 entitled “TECHNIQUE FOR USING INFRASTRUCTURE MONITORING SOFTWARE TO COLLECT CYBER-SECURITY RISK DATA” and corresponding non-provisional U.S. patent application Ser. No. 14/871,855;
U.S. Provisional Patent Application No. 62/113,186 entitled “INFRASTRUCTURE MONITORING TOOL FOR COLLECTING INDUSTRIAL PROCESS CONTROL AND AUTOMATION SYSTEM RISK DATA” and corresponding non-provisional U.S. patent application Ser. No. 14/871,732;
U.S. Provisional Patent Application No. 62/113,165 entitled “PATCH MONITORING AND ANALYSIS” and corresponding non-provisional U.S. patent application Ser. No. 14/871,921;
U.S. Provisional Patent Application No. 62/113,152 entitled “APPARATUS AND METHOD FOR AUTOMATIC HANDLING OF CYBER-SECURITY RISK EVENTS” and corresponding non-provisional U.S. patent application Ser. No. 14/871,503;
U.S. Provisional Patent Application No. 62/114,928 entitled “APPARATUS AND METHOD FOR DYNAMIC CUSTOMIZATION OF CYBER-SECURITY RISK ITEM RULES” and corresponding non-provisional U.S. patent application Ser. No. 14/871,605;
U.S. Provisional Patent Application No. 62/114,865 entitled “APPARATUS AND METHOD FOR PROVIDING POSSIBLE CAUSES, RECOMMENDED ACTIONS, AND POTENTIAL IMPACTS RELATED TO IDENTIFIED CYBER-SECURITY RISK ITEMS” and corresponding non-provisional U.S. patent application Ser. No. 14/871,814; and
U.S. Provisional Patent Application No. 62/114,937 entitled “APPARATUS AND METHOD FOR TYING CYBER-SECURITY RISK ANALYSIS TO COMMON RISK METHODOLOGIES AND RISK LEVELS” and corresponding non-provisional U.S. patent application Ser. No. 14/871,136; and
U.S. Provisional Patent Application No. 62/116,245 entitled “RISK MANAGEMENT IN AN AIR-GAPPED ENVIRONMENT” and corresponding non-provisional U.S. patent application Ser. No. 14/871,547.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving, by a risk manager system, real-time data from a plurality of connected devices;
creating, by the risk manager system, a data model based on the real-time data;
analyzing, by the risk manager system, the data model to identify potential current threats;
predicting, by the risk manager system, potential threats;
notifying a user, by the risk manager system, of the potential current threats and predicted potential threats.

2. The method of claim 1, wherein the data model is analyzed by correlating the real-time data with cyber threat intelligence to discover patterns and to establish a correlation between the patterns in order to identify the potential current threats or predicted potential threats.

3. The method of claim 1, wherein analyzing the data model includes identifying security gaps which contribute to the potential current threats or predicted potential threats.

4. The method of claim 1, further comprising prioritizing the potential current threats or predicted potential threats.

5. The method of claim 1, wherein notifying the user is performed by one of email notification, text message notification, or via a dashboard.

6. The method of claim 1, wherein the predicted potential threats are predicted based on at least one of the data model, cyber-threat intelligence, or the potential current threats.

7. The method of claim 1, wherein the real-time data includes one or more of system and process events, system and application logs, system diagnostics, system performance, network device logs, control system network traffic, and system configuration and policy data.

8. A risk manager system comprising:
a controller; and
a memory, the risk manager system configured to:
receive real-time data from a plurality of connected devices;
create a data model based on the real-time data;
analyze the data model to identify potential current threats;
predict potential threats;
notify a user of the potential current threats and predicted potential threats.

9. The risk manager system of claim 8, wherein the data model is analyzed by correlating the real-time data with cyber threat intelligence to discover patterns and to establish a correlation between the patterns in order to identify the potential current threats or predicted potential threats.

10. The risk manager system of claim 8, wherein analyzing the data model includes identifying security gaps which contribute to the potential current threats or predicted potential threats.

11. The risk manager system of claim 8, wherein the risk manager system is further configured to prioritize the potential current threats or predicted potential threats.

12. The risk manager system of claim 8, wherein notifying the user is performed by one of email notification, text message notification, or via a dashboard.

13. The risk manager system of claim 8, wherein the predicted potential threats are predicted based on at least one of the data model, cyber-threat intelligence, or the potential current threats.

14. The risk manager system of claim 8, wherein the real-time data includes one or more of system and process events, system and application logs, system diagnostics, system performance, network device logs, control system network traffic, and system configuration and policy data.

15. A non-transitory machine-readable medium encoded with executable instructions that, when executed, cause one or more processors of a risk manager system to:
receive real-time data from a plurality of connected devices;
create a data model based on the real-time data;
analyze the data model to identify potential current threats;
predict potential threats;
notify a user of the potential current threats and predicted potential threats.

16. The non-transitory machine-readable medium of claim 15, wherein the data model is analyzed by correlating the real-time data with cyber threat intelligence to discover patterns and to establish a correlation between the patterns in order to identify the potential current threats or predicted potential threats.

17. The non-transitory machine-readable medium of claim 15, wherein analyzing the data model includes identifying security gaps which contribute to the potential current threats or predicted potential threats.

18. The non-transitory machine-readable medium of claim 15, wherein the instructions further cause the one or more processors of the risk manager system to prioritize the potential current threats or predicted potential threats.

19. The non-transitory machine-readable medium of claim 15, wherein notifying the user is performed by one of email notification, text message notification, or via a dashboard.

20. The non-transitory machine-readable medium of claim 15, wherein the predicted potential threats are predicted based on at least one of the data model, cyber-threat intelligence, or the potential current threats.
